(19) United States
(12) Patent Application Publication
(10) Pub. No.: US 2026/0310477 A1
(43) Pub. Date: Oct. 8, 2026

(54) Method For Anchoring an Interactive Training System

(71) Applicant: Inspire Solutions, LLC, Knoxville, TN (US)

(72) Inventors: Matthew J. SCHENK, Knoxville, TN (US); Sam Matthew Johnston, Athens, TN (US); Steven L. Powers, Knoxville, TN (US)

(73) Assignee: Inspire Solutions, LLC, Knoxville, TN (US)

(21) Appl. No.: 19/346,982

(22) Filed: Oct. 1, 2025

Related U.S. Application Data
(60) Provisional application No. 63/785,266, filed on Apr. 8, 2025.

(51) Int. Cl. G06F 9/451; G06T 19/00

(52) U.S. Cl. CPC G06F 9/453; G06T 19/006

(57) ABSTRACT

A method for anchoring an interactive system for training and guiding cleaning professionals in the use of janitorial and cleaning product to clean surfaces within a room, includes a trainer mode and a trainee mode. The trainer selects a trainer anchor corner in the room that is selectable from the aerial view of the room displayed to the trainer and is a physical and fixed corner of the room. The trainee is prompted to provide an anchor corner to match the anchor corner left by the trainer.

### FIELD

This disclosure relates to the field of education, training and support and reinforcement of training. More particularly, this disclosure relates to a method for anchoring an interactive janitorial training system utilized by (1) a trainer to set up a room to be cleaned for interaction with a trainee learning how to clean the room, (2) a trainee learning to clean the room, and (3) a trained graduate after training.

### BACKGROUND

Improvement is desired in systems for training cleaning professionals in the proper and safe use of janitorial and cleaning products, and their application to specific cleaning requirements of a location without having to have a trainer individually present with each trainee through the training process. Also desired is ongoing support and reinforcement of the training to graduates of the training, and monitoring and monitor and record performance of the training graduates in their capacity as cleaning professionals.

The present disclosure is an interactive computer training system that is configured to be utilized by (1) a trainer to set up a room to be cleaned with markers for interaction with a trainee learning how to clean the room, (2) a trainee learning to clean the room, and (3) a trained graduate after training.

The disclosure further improves existing technology by enabling the trainer to easily provide an anchor corner in the room for the mobile computing device utilized as a reference in regard to virtual surface markers left by the trainer. The mobile computing device prompt the trainee to select and provide an anchor corner to match the anchor corner left by the trainer. The matching of the anchor corners ensures that the locations of the virtual surface markers generated for viewing by the trainee are the same as the locations of the surface markers set by the trainer.

The anchor corner selected according to the disclosure is a physical and fixed corner, such as a wall corner, that is selectable from an aerial view of the room, as opposed to a corner of furnishing or removable items of the room. For example, in a room that had changed in spatial arrangement, such as removal of a table or rearrangement of chair rows, if a corner of a chair or table is used, and the item is removed, the system would no longer be able to ensure that the locations of the surface markers are accurate. A table or chair or the like is not physically fixed, as it could be easily moved or removed from the room.

The ability to gain proper spatial positioning of the mobile computing device in a space is critical. In the present disclosure, having the trainer initially scan the space and select as the anchor point a corner that is selectable from an aerial view of the room has enabled enhanced operability and functionality and is a significant improvement over existing technology.

This improvement avoids the need to place a physical marker in the room such as a scannable QR code or unique optical pattern on a sticker or the like for finding the anchor point. A QR code or the like having the anchor point information is undesirable as the QR code or like sticker could be errantly removed or relocated, for example.

This improvement also enables use of the system if a space, such as a room, has changed in spatial arrangement, such as removal or rearrangement of objects or fixtures in the room. This improvement also enables use of the system in spaces of similar type and layout. Thus, once the system is configured for a room type, it can be utilized for similar room types without the need for each room to be set up by the trainer.

For example, if recognition of a room is limited to the actual room scanned, other rooms of similar type and close in layout would fail to be recognizable if a spatial aspect varied slightly. The system of the present disclosure and the described selection of a physically fixed anchor corner advantageously enables the system to be utilized for similar room types without the need for each room to be set up by the trainer.

### SUMMARY

The disclosure provides a method of anchoring an augmented reality experience for an interactive system for training and guiding cleaning professionals in the use of janitorial and cleaning product to clean surfaces within a plurality of rooms of a facility.

In one aspect, the method includes the steps of: (1) providing a database of information about the facility and the rooms of the facility to be cleaned, the information including a name for the facility and names of the rooms of the facility and locations of the rooms at the facility; and (2) having a trainer select and set up one of the rooms to be cleaned for interaction with a trainee learning how to clean the room.

The trainer sets up one of the rooms by: a.) selecting one of the rooms and accessing via a trainer computer the database of information corresponding to the selected room, wherein the interactive system recognizes the trainer and loads pre-selective interactive display screens for interaction with the trainer, b) scanning the selected room with the trainer computer to generate and store an augmented reality map of room surfaces in the room, with the interactive system also displaying an aerial view of the room and prompting the trainer to select a trainer anchor corner in the room that is selectable from the aerial view of the room displayed to the trainer and is a physical and fixed corner of the room, c) interacting with the augmented reality map and selecting surfaces in the room on the map and selecting a surface name for selected surfaces and setting surface markers on the map for each of the selected surfaces to provide room information for each of the selected rooms, the interactive system creating a checklist of the selected surfaces, and saving the room information for the selected room.

The method also includes (3) having a trainee interact with the training system to receive training. This is done by: a. the trainee going to one of the rooms selected by the trainer and having a trainee computer that recognizes the trainee, the trainee accessing the room information saved by the trainer for the selected room, b. the trainee computer displaying to the trainee the stored augmented reality map of the selected room with the surface markers set by the trainer and the aerial view of the scanned room, c. the trainee being directed by the trainee computer to select from the displayed aerial view and augmented realty map a trainee anchor corner to match the trainer anchor corner left by the trainer, and d. the trainee selecting one of the surface markers and the trainee computer displaying to the trainee one or more tasks to be performed by the trainee, with the trainee thereafter taking action to complete the task, and interacting with the trainee computer to indicate that the task has been completed by the trainee.

The disclosure also provides an interactive system for training and guiding cleaning professionals in the use of janitorial and cleaning product to clean surfaces within a room.

In one aspect, the system includes (1) a database of information about the facility and the rooms of the facility to be cleaned, the information including a name for the facility and names of the rooms of the facility and locations of the rooms at the facility; (2) a trainer mode used by a trainer to select and set up one of the rooms to be cleaned for interaction with a trainee learning how to clean the room, and (3) a trainee mode in which a trainee interacts with the training system to receive training.

The trainer mode including the steps of: a. the trainer selecting one of the rooms and accessing via a trainer computer the database of information corresponding to the selected room, wherein the interactive system recognizes the trainer and loads pre-selective interactive display screens for interaction with the trainer, b. the trainer scanning the selected room with the trainer computer to generate and store an augmented reality map of room surfaces in the room, with the interactive system also displaying an aerial view of the room and prompting the trainer to select a trainer anchor corner in the room that is selectable from the aerial view of the room displayed to the trainer and is a physical and fixed corner of the room, c. the trainer interacting with the augmented reality map and selecting surfaces in the room on the map and selecting a surface name for selected surfaces and setting surface markers on the map for each of the selected surfaces to provide room information for each of the selected rooms, the interactive system creating a checklist of the selected surfaces, and d. the trainer saving the room information for the selected room.

The trainee mode includes the steps of: a. the trainee being directed by the trainer to one of the rooms selected by the trainer and having a trainee computer that recognizes the trainee, the trainee accessing the room information saved by the trainer for the selected room, b. the trainee computer displaying to the trainee the stored augmented reality map of the selected room with the markers set by the trainer and the aerial view of the scanned room, c. the trainee being directed by the trainee computer to select from the displayed aerial view and augmented realty map a trainee anchor corner to match the trainer anchor corner left by the trainer, and d. the trainee selecting one of the surface markers and the trainee computer displaying to the trainee one or more tasks to be performed by the trainee, with the trainee thereafter taking action to complete the task, and interacting with the trainee computer to indicate that the task has been completed by the trainee.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIGS. 1A-8A are screen displays depicting interaction of a trainer with the training system to set up training according to the disclosure.

FIGS. 1B-18B depict interaction of a trainee with the training system.

FIGS. 1C-15C depict interaction of a trained graduate with the training system after training.

### DETAILED DESCRIPTION

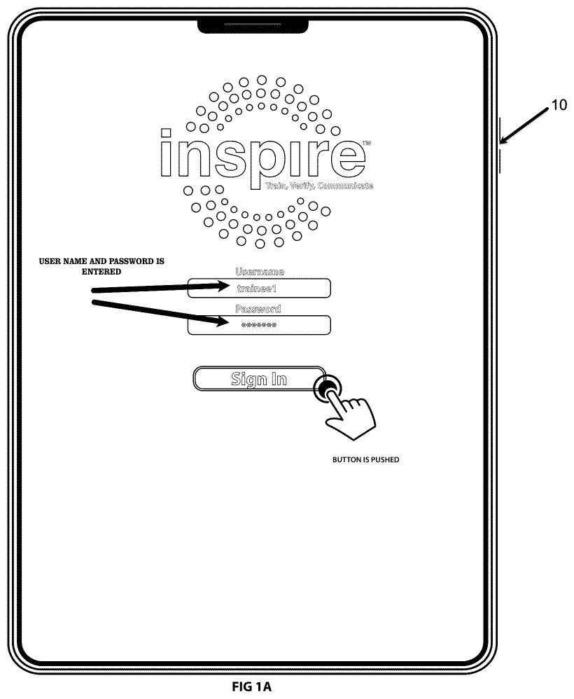

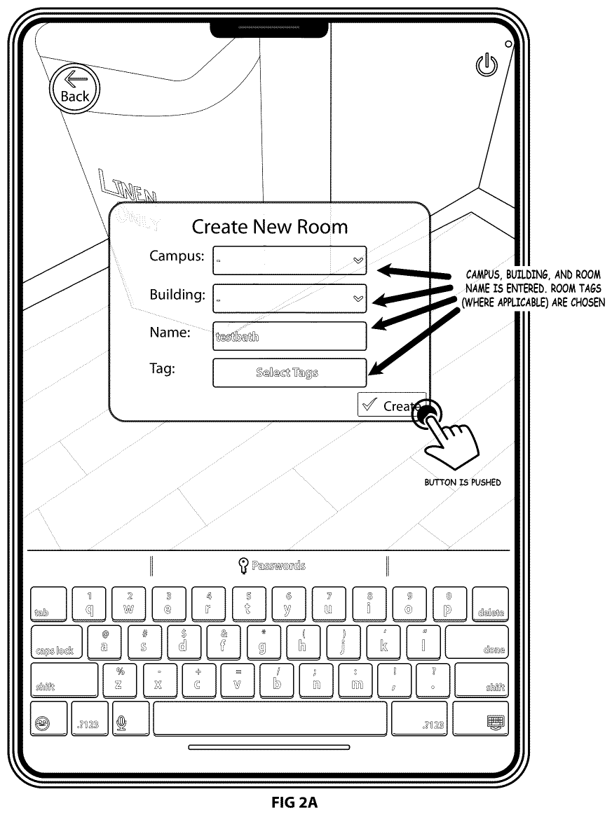

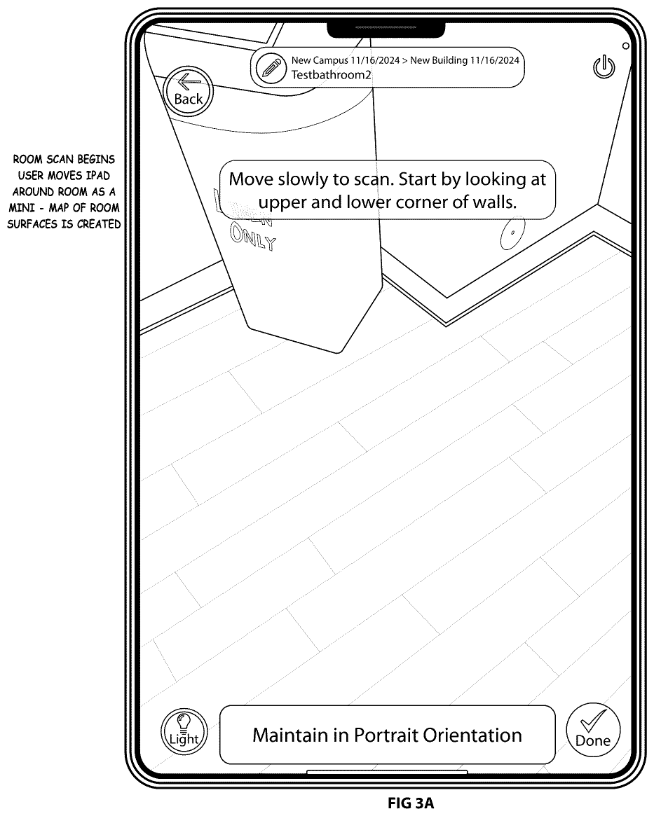

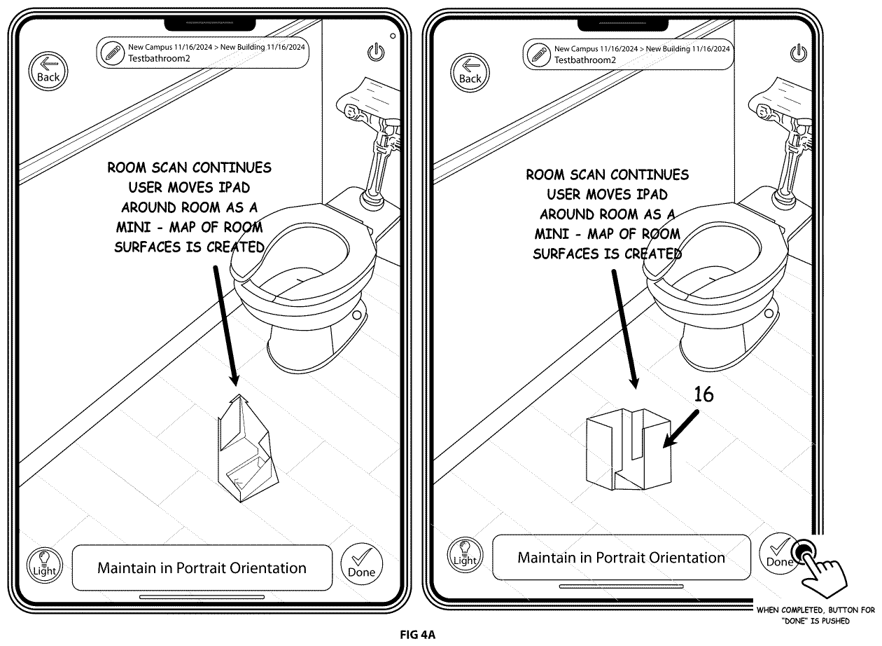

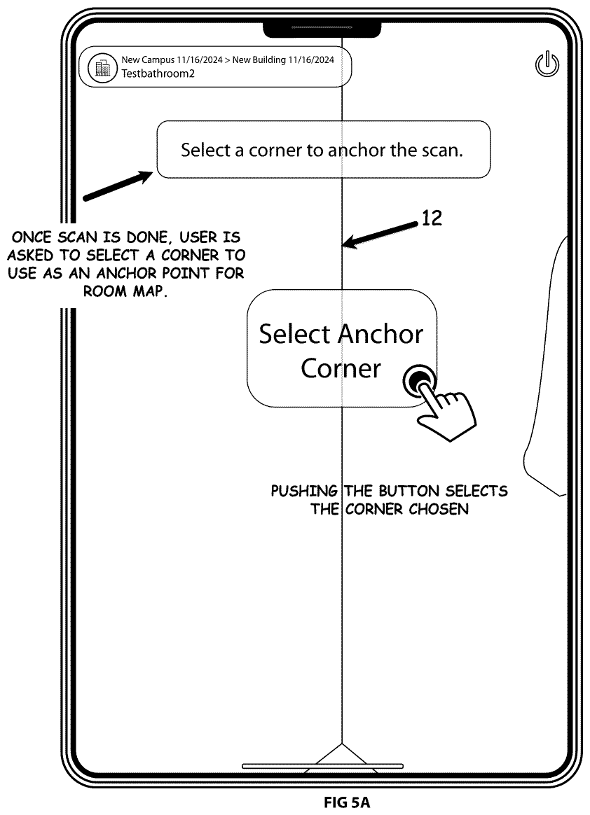

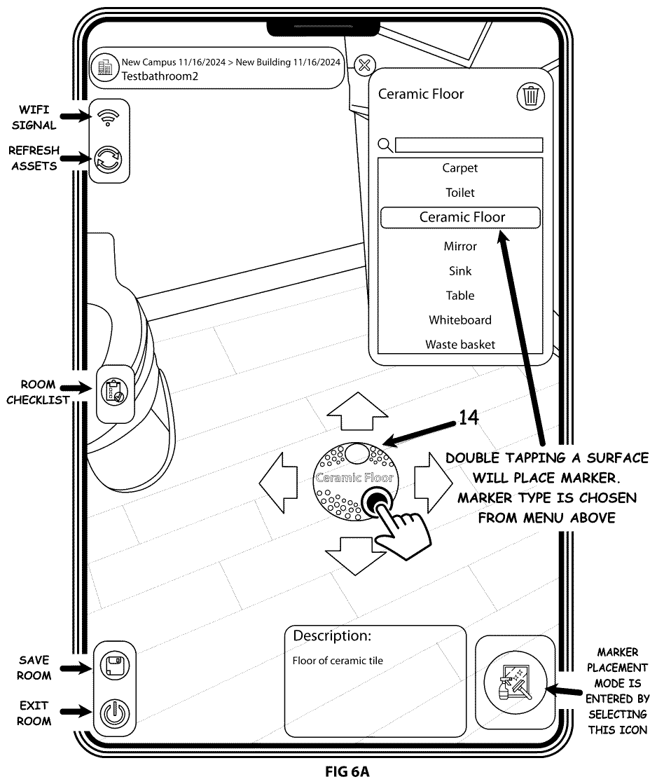

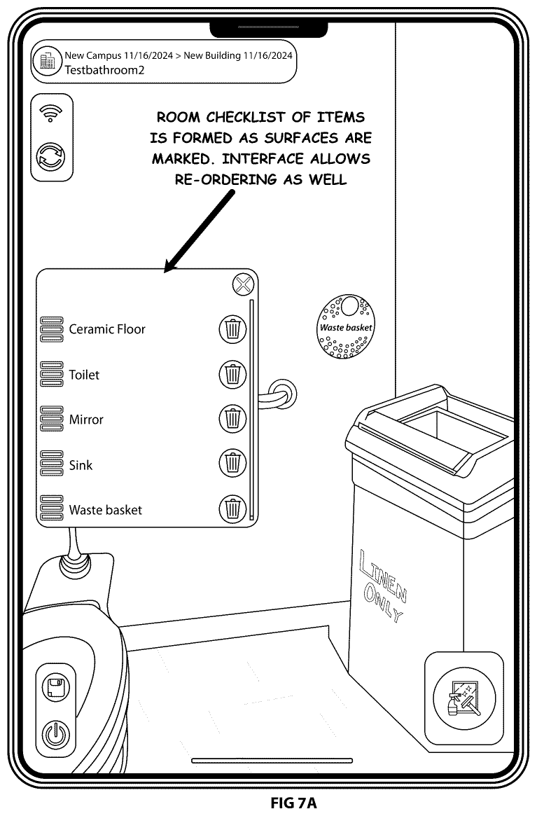

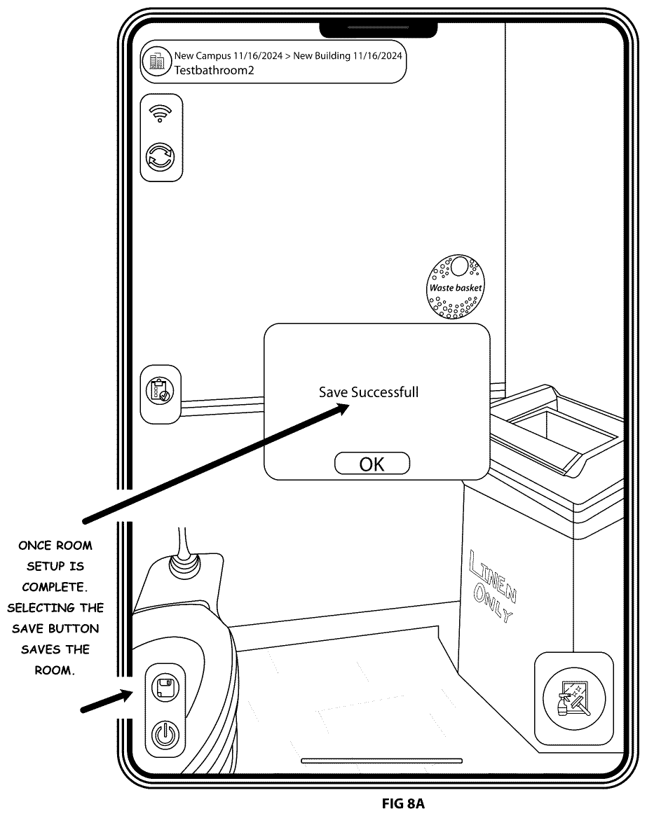

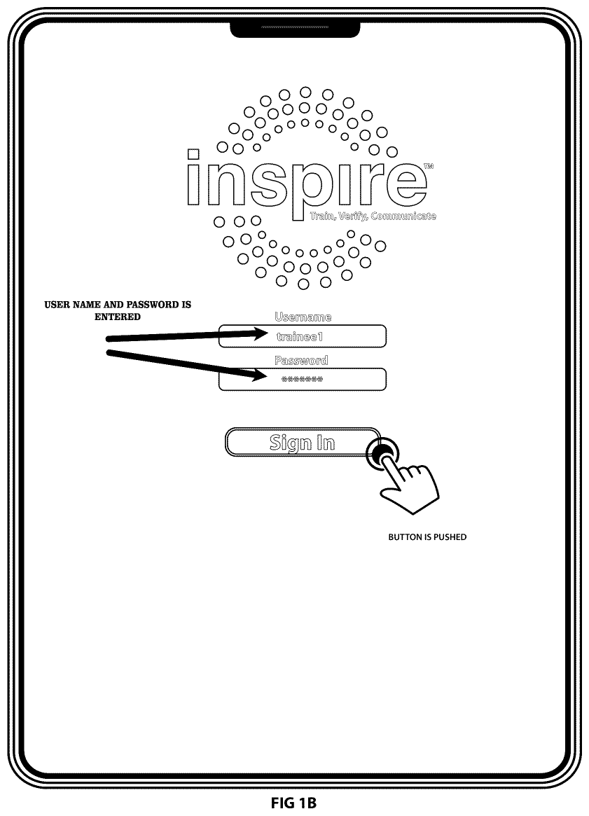

With reference to the drawings, an interactive computer training system and method for anchoring according to the disclosure are shown first in FIGS. 1A-8A as used by a trainer to set up a space, such as a room to be cleaned, for interaction with a trainee learning how to clean the room. This is an initial step prior to the system being used by a trainee to learn how to clean the room or other space.

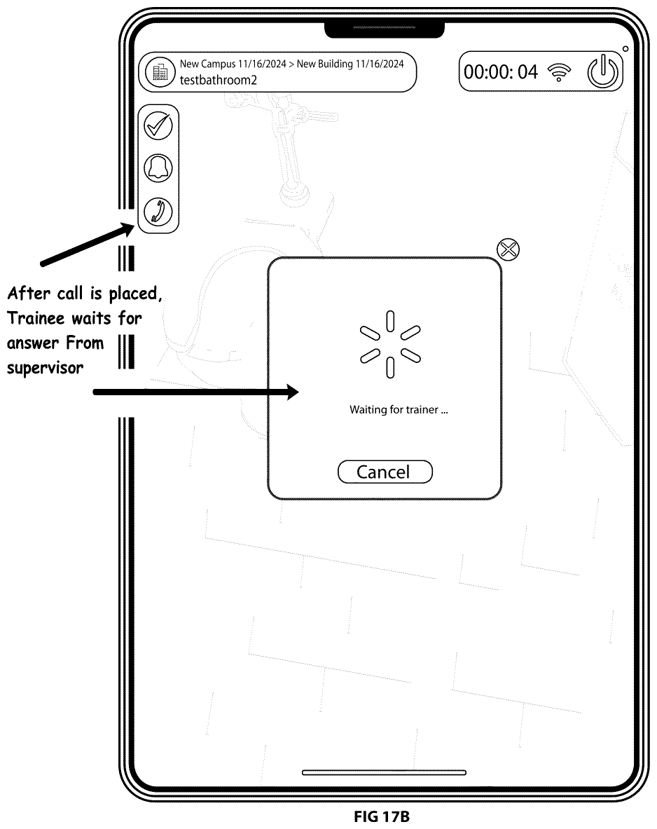

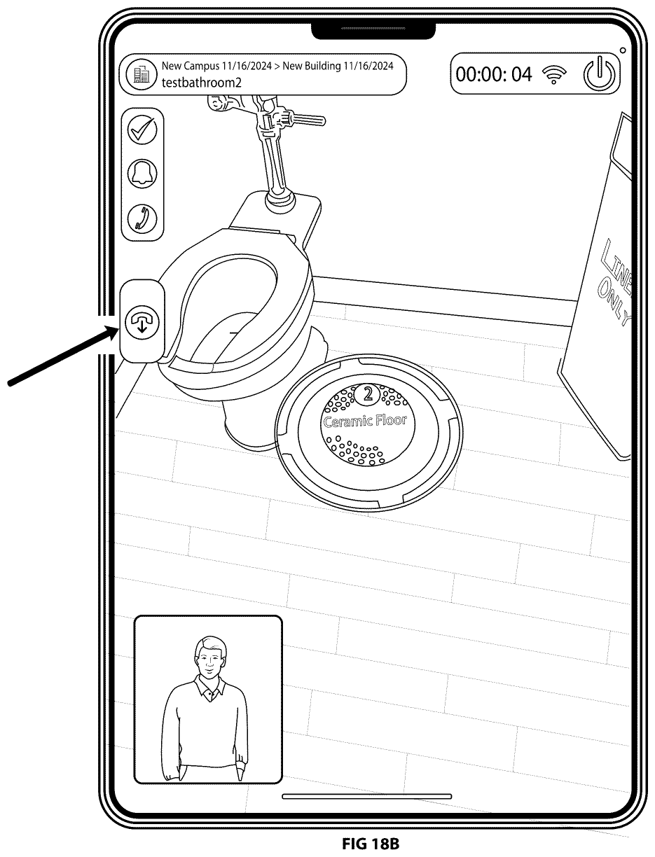

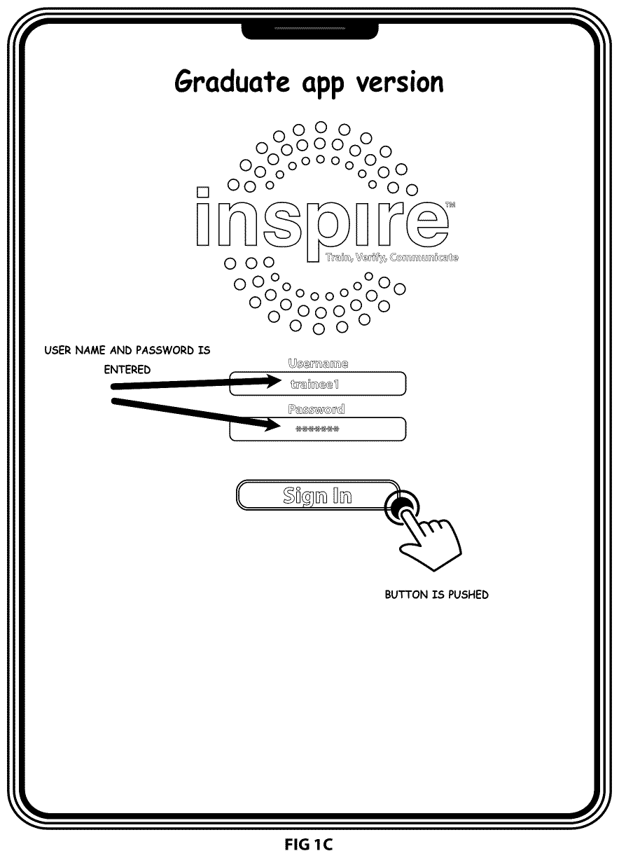

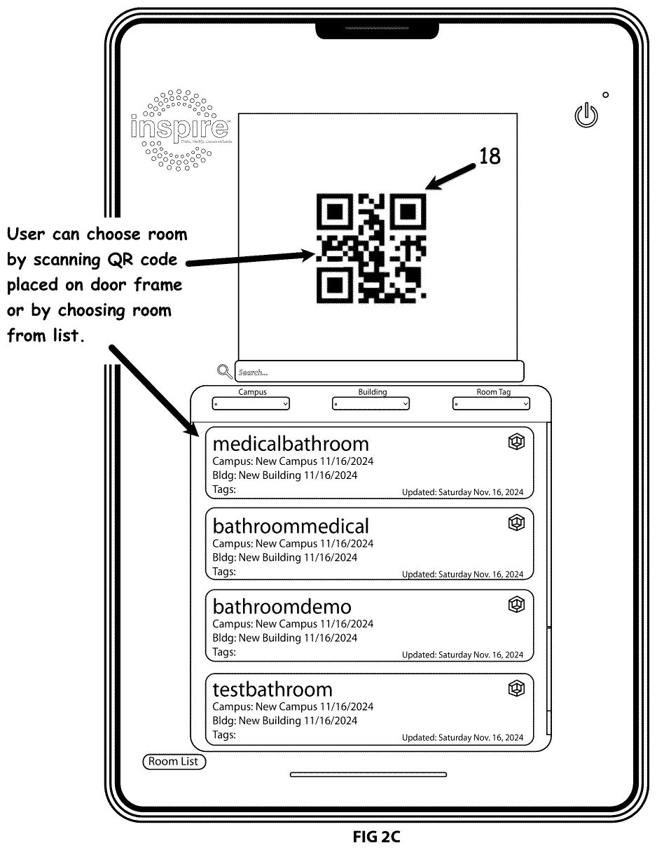

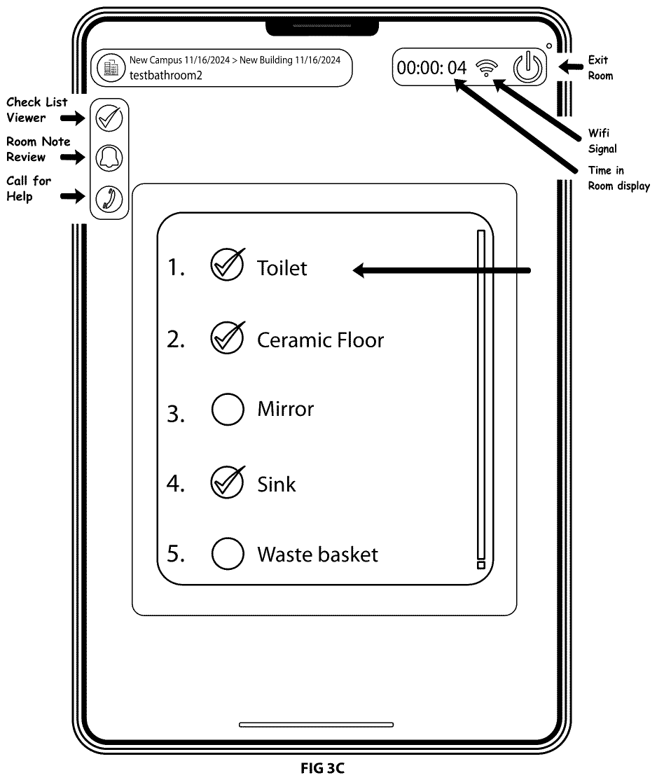

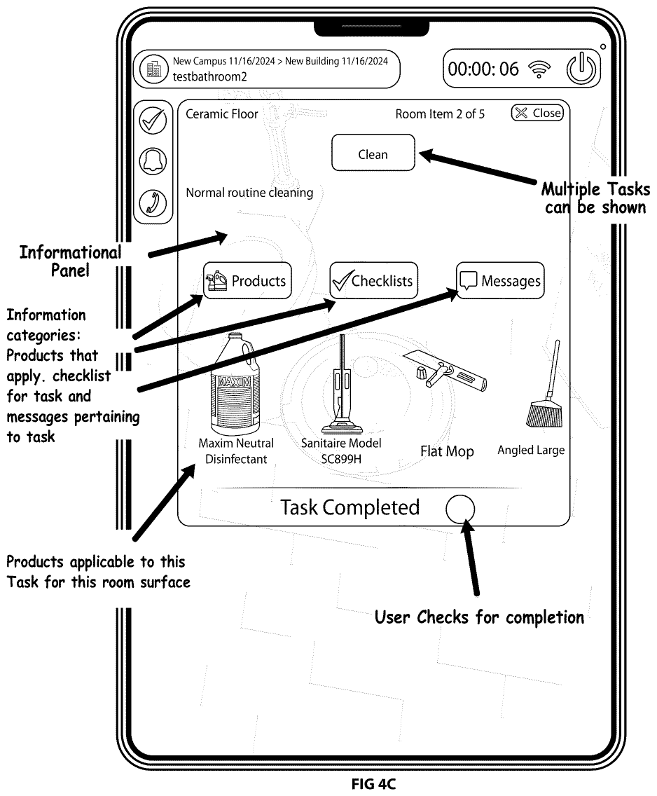

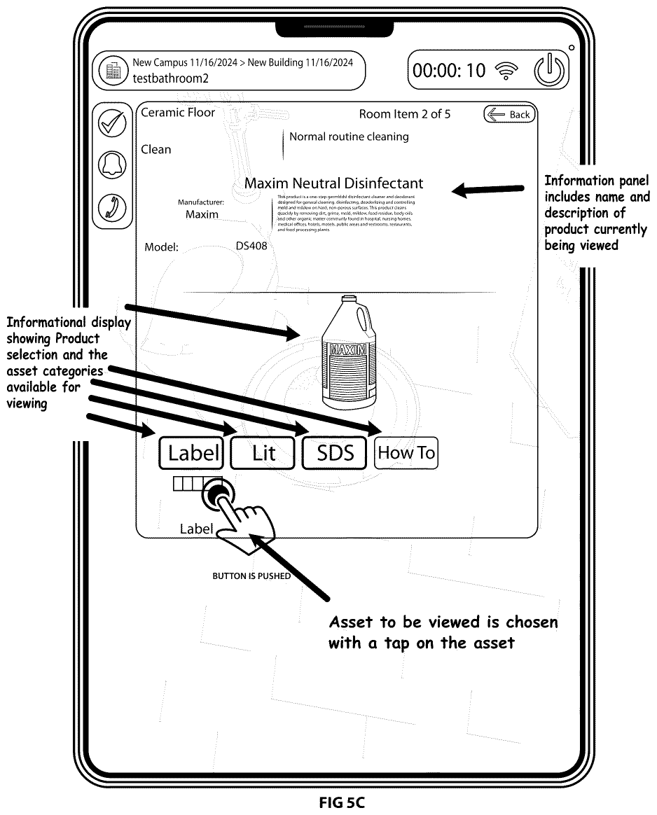

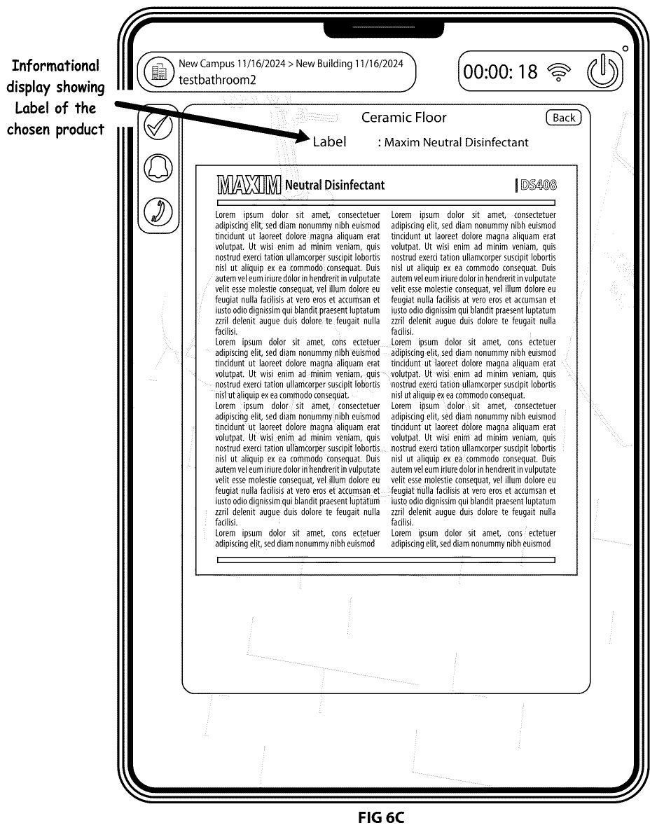

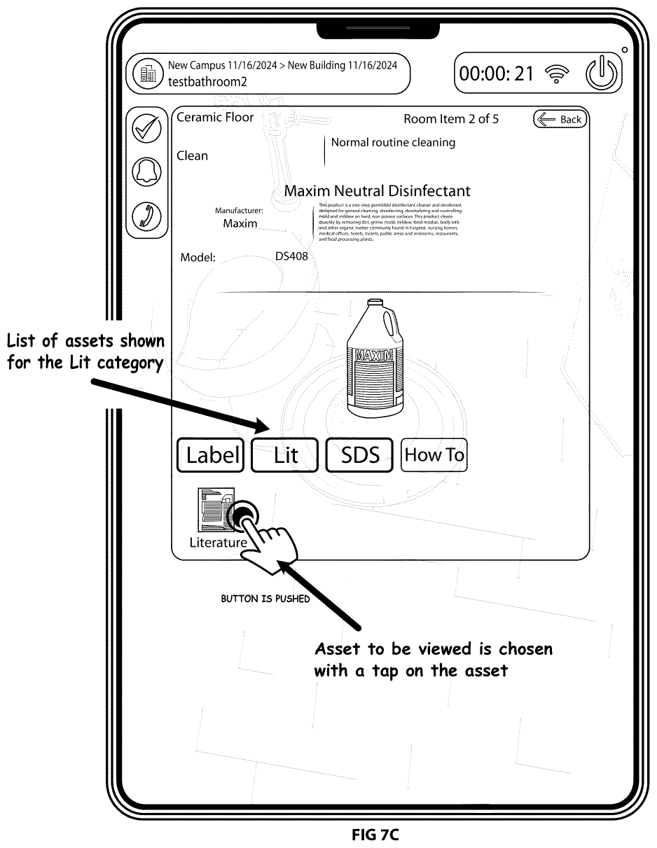

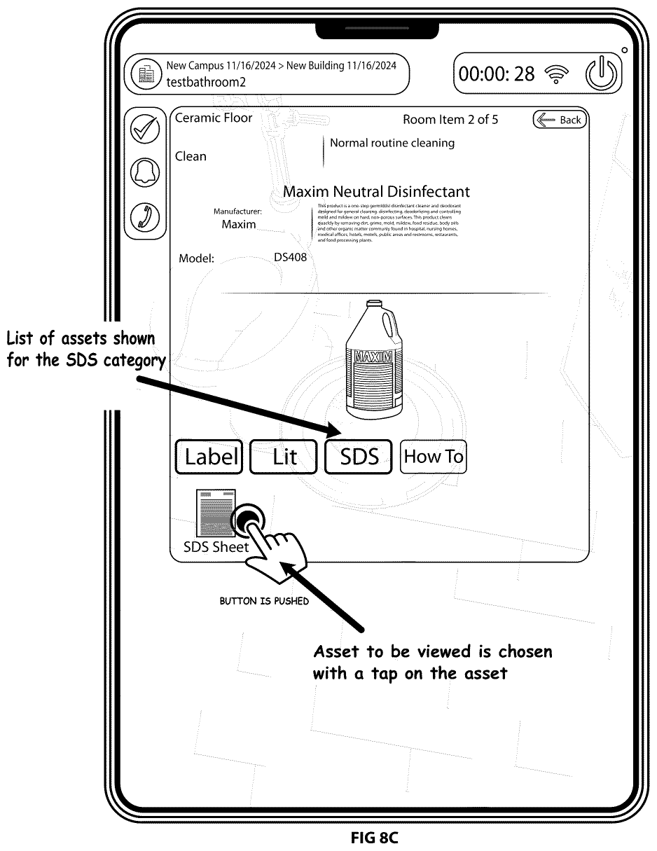

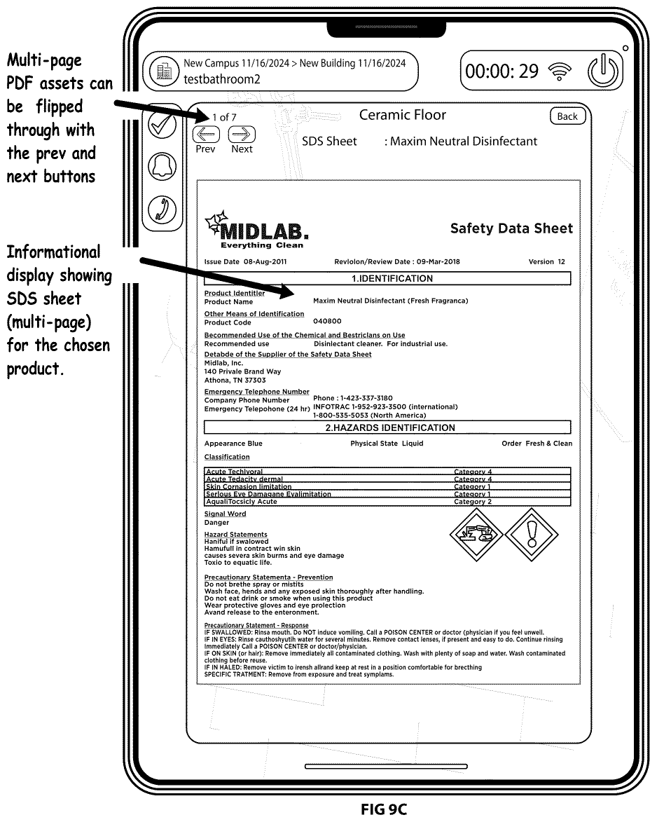

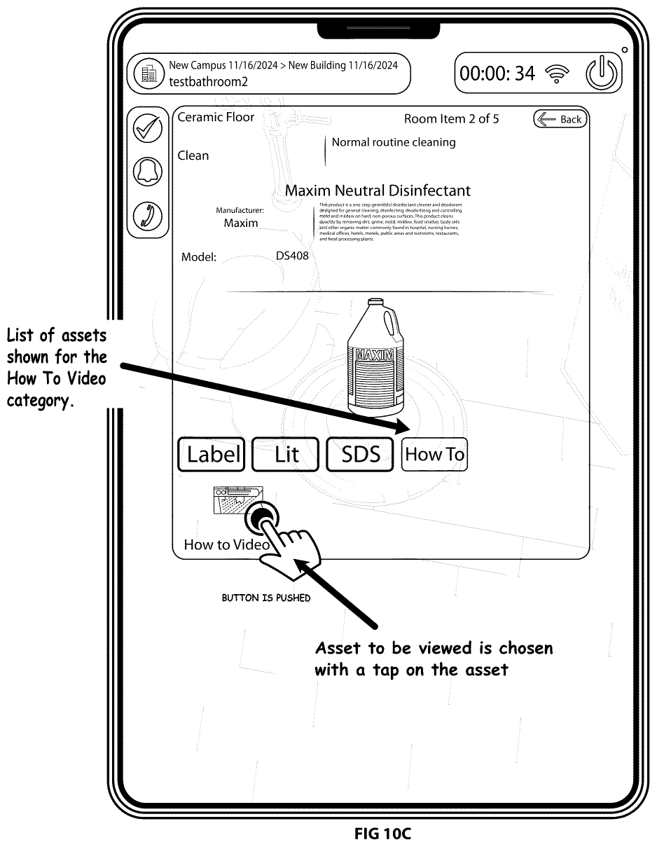

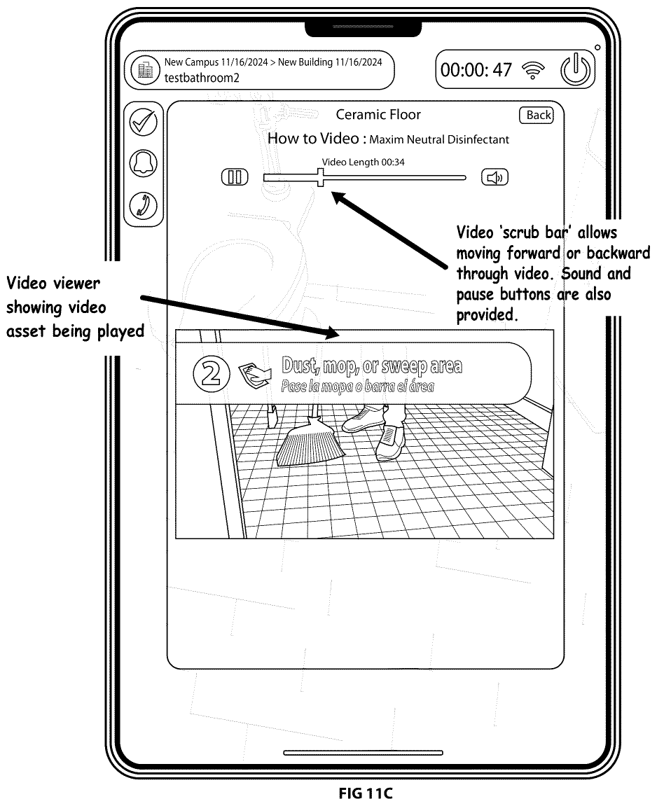

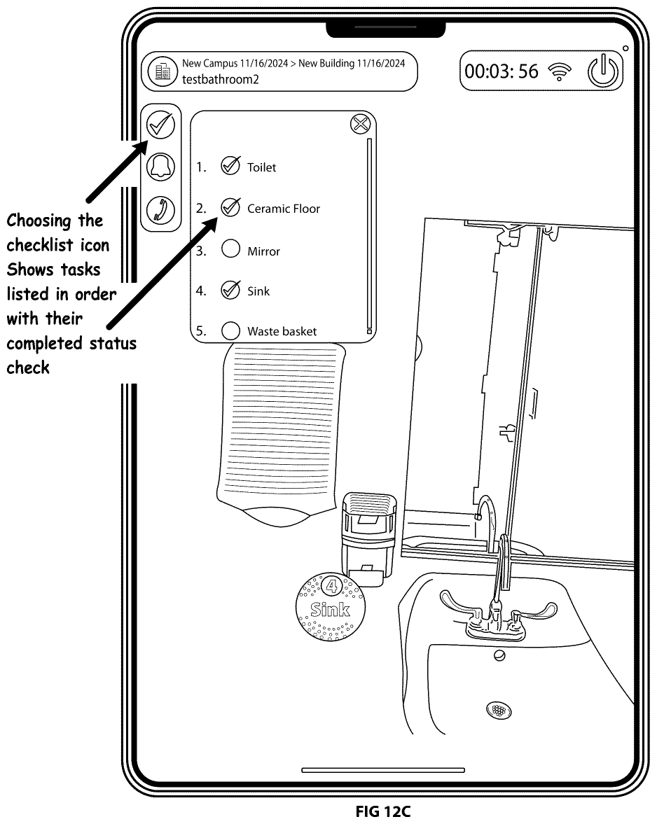

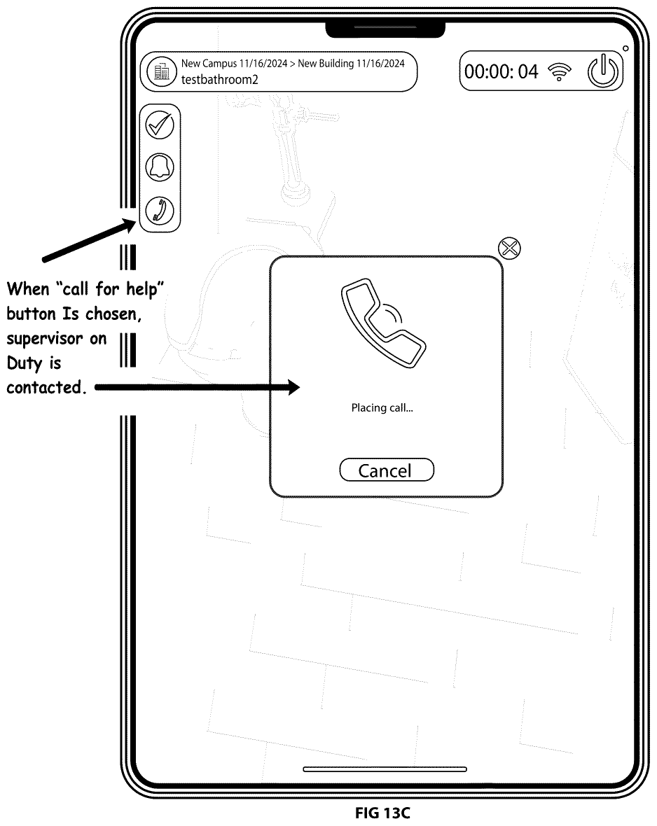

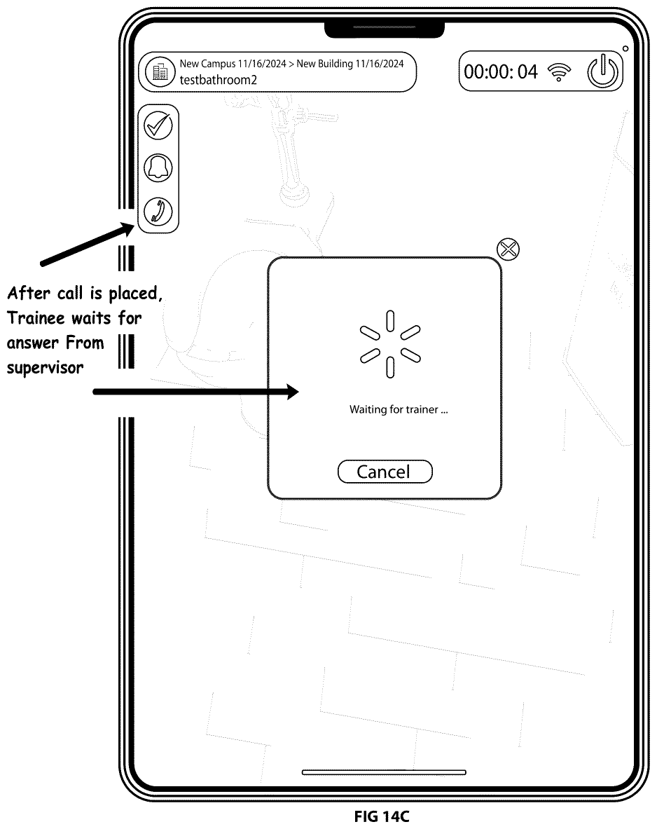

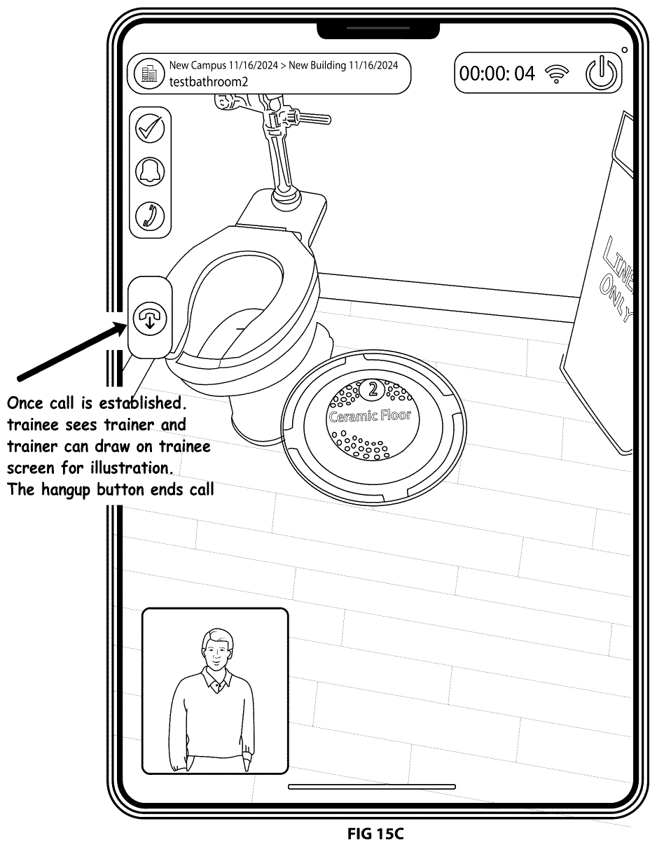

FIGS. 1B-18B show interaction of a trainee with the training system to receive training. FIGS. 1C-15C depict interaction of a trained graduate with the training system to receive reinforcement and support after training and to track the activities of the trained graduate as they perform their cleaning activities.

The training system is configured to enable a trainer to set up training for cleaning a room, actual training of a trainee, and subsequent reinforcement and support for a trained graduate. It will be appreciated that the training system could be adapted for other training purposes aside from cleaning a room.

The system empowers cleaning professionals and supervisors with advanced tools for efficient task management, robust tracking, and seamless communication.

The system enables the trainer to easily provide an anchor corner in the room for the mobile computing device utilized. The system also prompts the trainee to provide an anchor corner to match the anchor corner left by the trainer. The use of such matching anchor corners ensures that the locations of markers set by the trainer are the same as viewed by the trainee. The use of anchor corners as described herein also enables the system to be utilized for similar room types without the need for each room to be set up by the trainer.

Additional features of the training system include secure access, GPS tracking, room entry tracking, task management, a message center, and two-way communication between a trainer/supervisor and trainee/trained graduate. The system can also support multiple languages.

### FIGS. 1A-8A—Trainer

The interactive computer training system is accessed by the trainer, the trainee and the trained graduate via a mobile computer, such as a tablet, such as an I-Pad tablet having a touchscreen, a camera, internet/wireless access, and global positioning system (GPS) capabilities, coupled with operative software of the training system and data storage. The data storage may be local on the mobile computer and/or remote, such as cloud storage.

As noted, the described embodiment relates to training a cleaning professional or the like in the cleaning of a space or location such as a room. For purpose of example, the space will be described herein in the context of a room. The room can be any definable enclosed area having enclosing walls and a variety of surfaces, fixtures or other locations in the room of which cleaning is desired. The room shown in the drawings is a bathroom. FIGS. 1A-8A are screen displays of the tablet 10 depicting interaction of a trainer with the training system to set up training for cleaning the bathroom.

FIG. 1A depicts the trainer accessing the training system via a tablet 10 having user/password access. The training system recognizes whether the user is a trainer or trainee or a graduate via the username to load the appropriate interactive display screens and options. It will be understood that the system is pre-loaded with user information and other information about the facility that the training is configured for. The example shown is for a university having a number of different campuses having various buildings.

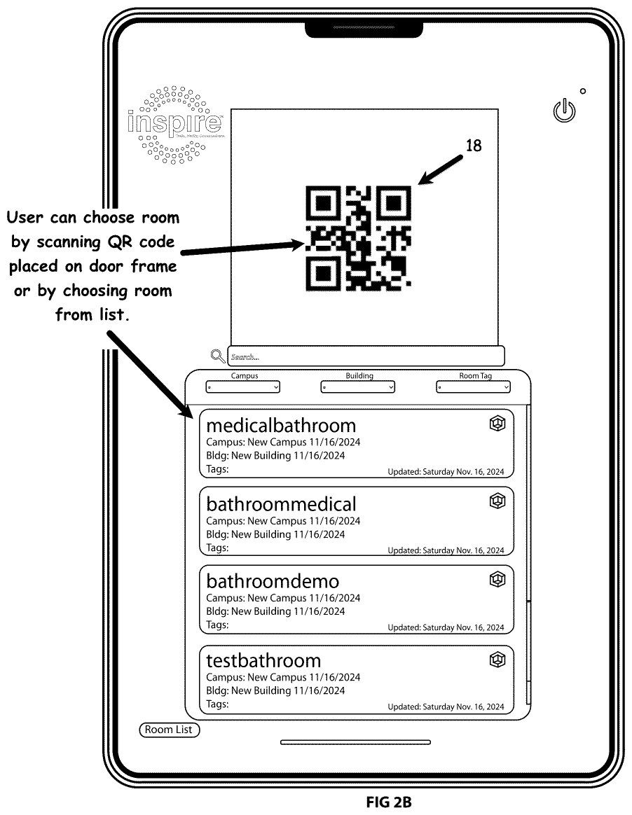

FIG. 2A depicts the trainer creating a an augmented reality map of a physical room in which training will be administered to a trainee, in this case a bathroom. It will be understood that the training will often involve multiple different rooms each having different cleaning requirements. Information about the facility is pre-loaded into the database and the trainer can click through the information and select the location of the room. The trainer then names the room. In this case, the example shows it as testbath in newbuilding at newcampus. Typically, the names will correspond to the real names used by the facility.

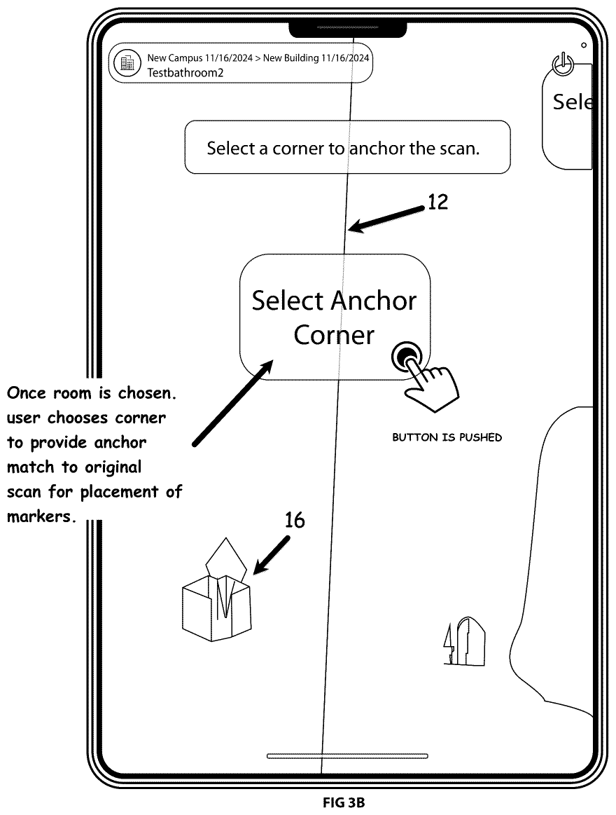

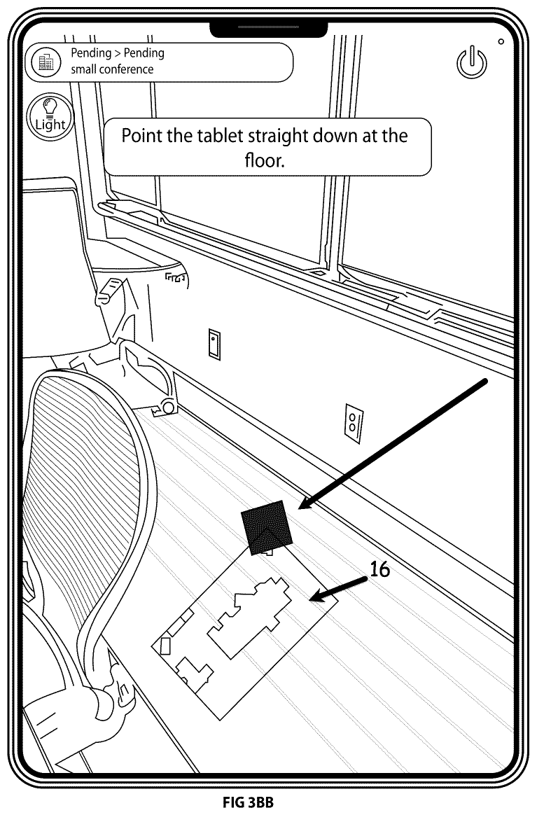

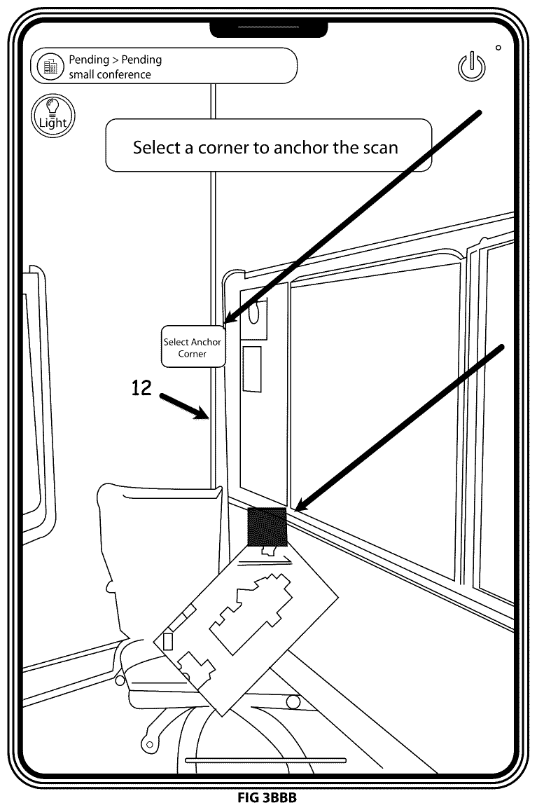

FIGS. 3A-5A depicts the trainer scanning the room. The trainer scans the room to generate and store an augmented reality map of room surfaces in the room. At the conclusion of taking the scan, the trainer is prompted to select an anchor point in the room, namely a corner that is selectable from an aerial view of the room. Anchor corner 12 is depicted as the selected anchor corner and it is a physical and fixed corner, namely a wall corner.

The anchor corner 12 and manner of selection by the trainer and utilization by the trainee is a key improvement over existing technology. As will be noted, the system is configured to require the trainer to select an anchor corner location generated by the system to be a corner. More specifically, and explained more fully below, this anchor corner is selected to be a corner that is selectable from an aerial view of the room or space.

Selection of the anchor point to be an anchor corner selectable from an aerial view of the room facilitates a subsequent trainee to quickly locate the anchor corner. This allows the trainee that has entered the room to know which corner should be viewed for the anchor selection. The selected anchor corner thereafter serves as a spatial point is used to locate the mobile computer in the room rather than depending on fixtures in the room or consistency of geometric patterns in the room. The use of anchor corners as described herein also advantageously enables the system to be utilized for similar room types without the need for each room to be set up by the trainer.

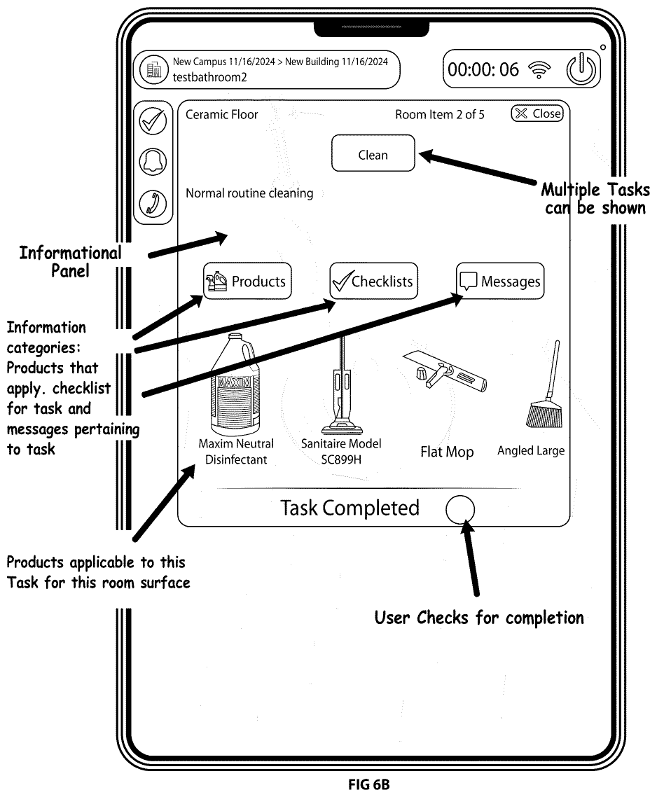

FIG. 6A shows the trainer selecting surfaces in the room on the augmented reality generated map. The trainer selects a surface name from a pre-loaded menu of names and then double taps at a location on the generated map to set a virtual surface marker 14 corresponding to the surface. In the example, the trainer selects “Ceramic Floor” and then double clicks on the floor in the map to set the virtual surface marker for that surface. The trainer may then select additional surfaces to set surface markers from the menu.

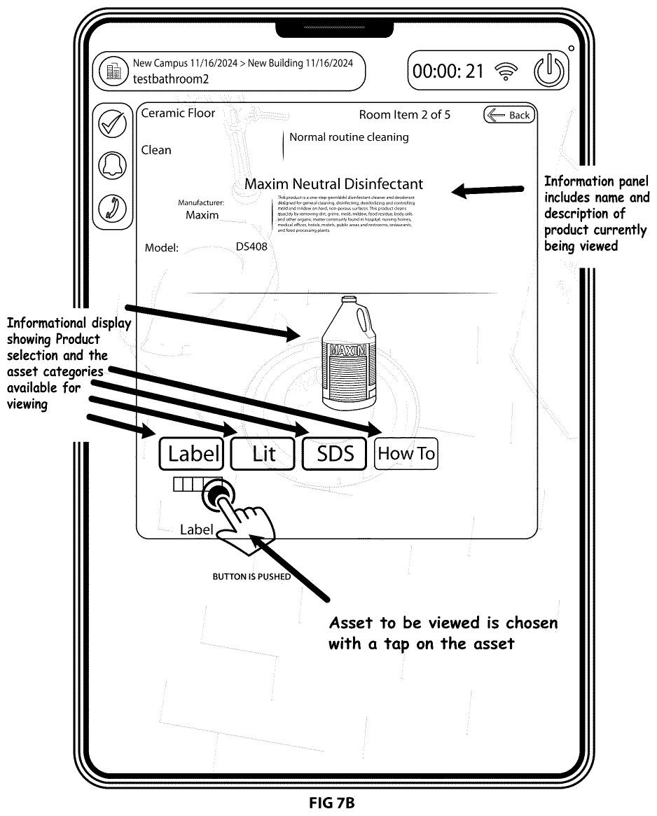

FIG. 7A depicts a checklist of surfaces that is formed as the names are assigned to surfaces in the room. The surfaces are ordered in the order named but this can be re-ordered as desired to create an order of cleaning to be followed by the trainee. The markers will bear a number corresponding to the order selected by the trainer.

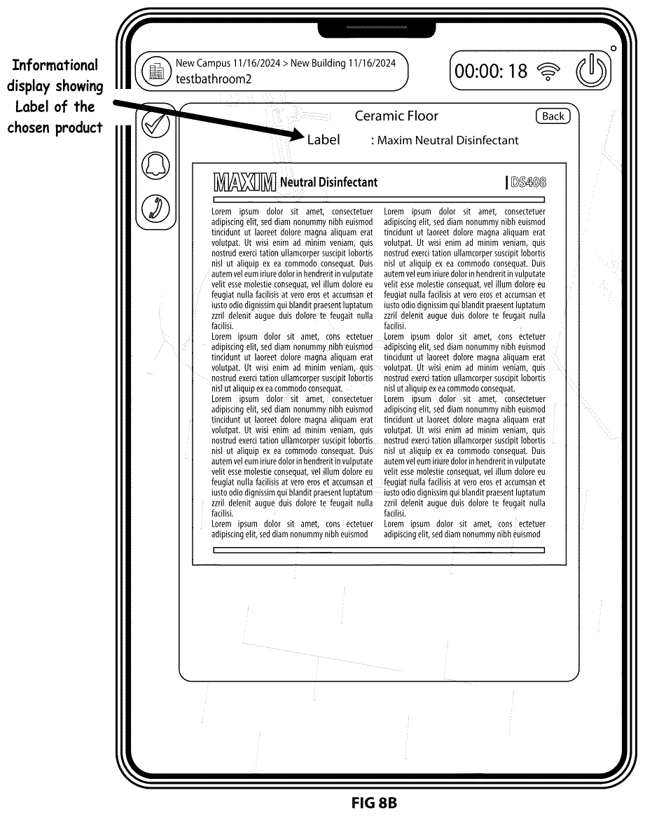

FIG. 8A depicts saving the room information once the selection of surfaces is completed. The trainer can leave indicia or indicium in the nature of a sticker or the like with a QR code of the room can be applied to the door or like of the room for scanning to pull up the room information. In this case, a QR code 18 is left by the trainer as depicted in FIG. 2B below. Alternatively, or in addition, the trainer can save the room information to a menu with the name of the room appearing on a pre-populated list.

The foregoing example will be repeated for each room to be created by the trainer for a given training session.

In regard to the foregoing, it is noted that the anchor corner 12 selected by the trainer is a physical and fixed corner, such as a wall corner, that is selectable from an aerial view 16 of the room displayed to the trainer by the system. The physical and fixed corner 12 is utilized as opposed to a corner of furnishing or removable items of the room. For example, in a room that had changed in spatial arrangement, such as removal of a table or rearrangement of chair rows, if a corner of a chair or table is used, and the item is removed, the system would no longer be operable.

The ability to gain proper spatial positioning of the mobile computing device in a space is critical. In the present disclosure, having the trainer initially scan the space and select as the anchor point, namely a physically fixed wall corner that is selectable from an aerial view of the room has enabled enhanced operability and functionality and is a significant improvement over existing technology.

This improvement avoids the need to place a physical marker in the room such as a scannable QR code or unique optical pattern that corresponds to the anchor corner. A physical marker for providing the anchor corner is undesirable as it could be errantly removed or relocated.

This improvement also enables use of the system if a space, such as a room, has changed in spatial arrangement, such as removal or rearrangement of objects or fixtures in the room. This improvement also enables use of the system in spaces of similar type and layout. Thus, once the system is configured for a room type, it can be utilized for similar room types without the need for each room to be set up by the trainer.

For example, if recognition of a room is limited to the actual room scanned, other rooms of similar type and close in layout would fail to be recognizable if a spatial aspect varied slightly. The system of the present disclosure and the described selection of a physically fixed anchor corner advantageously enables the system to be utilized for similar room types without the need for each room to be set up by the trainer.

### FIGS. 1B-18B

Turning now to FIGS. 1B-18B, the interactive training system is shown being used by a trainee learning to clean the room as set up by the trainer in FIGS. 1A-8A. The views are from the perspective of the trainee viewing the screen of the tablet 10 and the selected room.

In FIG. 1B the trainee signs in with username/password. The training system recognizes the trainee.

In FIG. 2B the trainee is prompted to scan the QR code 16 left by the trainer or select the room from a menu, such as a list pre-populated on the screen displayed to the trainee, to access the room information saved by the trainer. This also commences GPS tracking for monitoring arrival and departure time at the room, as well as room entry tracking. Further, the progress of the trainee through the various tasks the trainee is directed through is monitored.

In FIG. 3B the augmented reality map of the room previously scanned and generated by the trainer along with an aerial view of the scanned room are displayed to the trainee. The trainee is prompted to provide an anchor corner to match the anchor corner 12 left by the trainer. The alignment or matching of the anchor corner selected ensures that the locations of the surface markers are as set by the trainer.

FIG. 3BB and FIG. 3BBB show examples of how this is easily accomplished by providing to the trainee a view on the tablet 10 of a room map having an aerial view of the room with a visual reference of the anchor corner 12 selected by the trainer shown thereon. That is, displayed to the trainee is the augmented reality map of the room previously scanned and generated by the trainer along with an aerial view of the scanned room. This allows the trainee to easily see and select the same anchor corner. As shown the trainee can point the tablet 10 straight down at the floor of the room, with the anchor corner 12 of the room selected by the trainer clearly indicated and easily able to be selected by the trainee as the anchor corner.

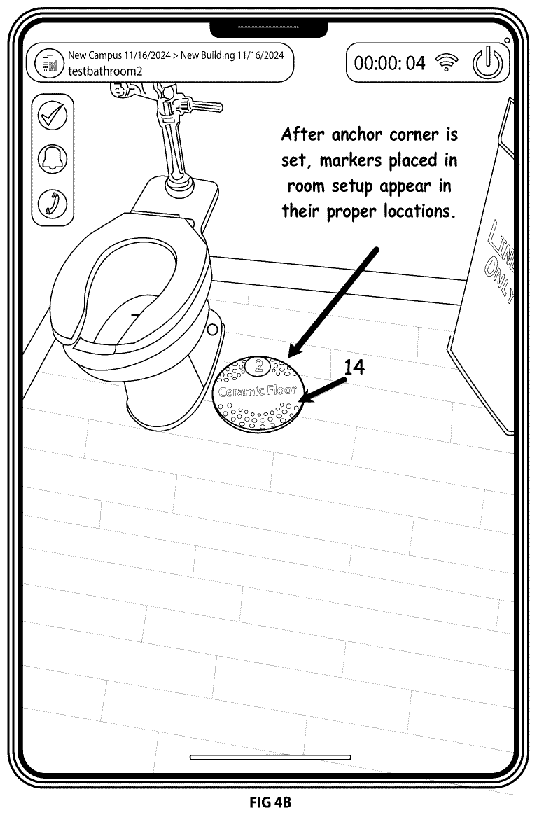

In FIG. 4B it is seen that displayed to the trainee is the room map with the surface markers set by the trainer. The surface markers include a number based on the desired cleaning order set by the trainer. Also, the training system begins tracking the GPS coordinates and time/duration at the GPS coordinates.

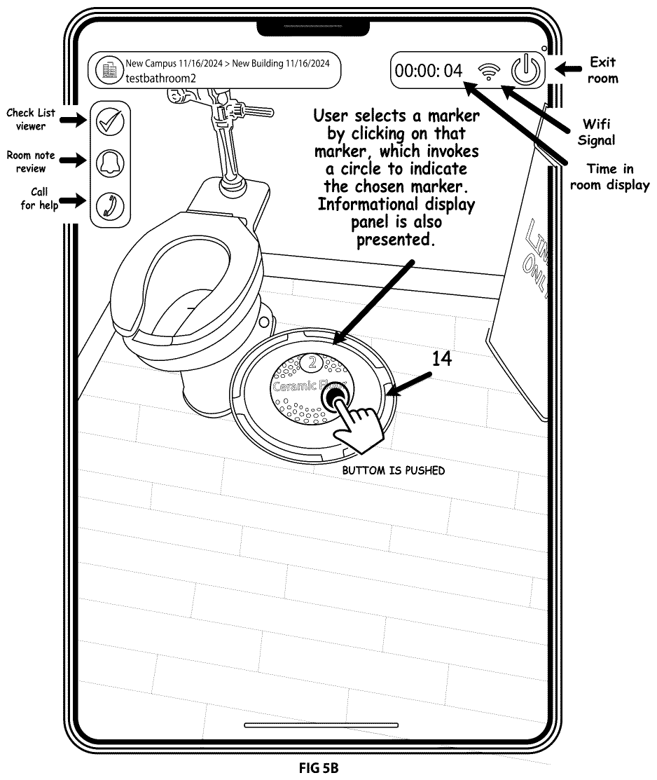

In FIG. 5B the trainee selects one of the surface markers 14 by double-tapping. An informational display panel is also presented to the trainee. As shown, this includes a checklist viewer, a room note review, and a call for help, any of which can be accessed by tapping.

In FIG. 6B, after the trainee has selected a marker, the informational panel expands and displays a task to be performed, such as cleaning. Multiple tasks can be shown. Also displayed are informational categories such as products, checklists, and messages. Also shown are pre-selected cleaning products applicable to the surface of the marker, in this case, the creaming floor. Once the cleaning task is completed the trainee checks the Task Completed icon and the duration it took to complete the task is noted.

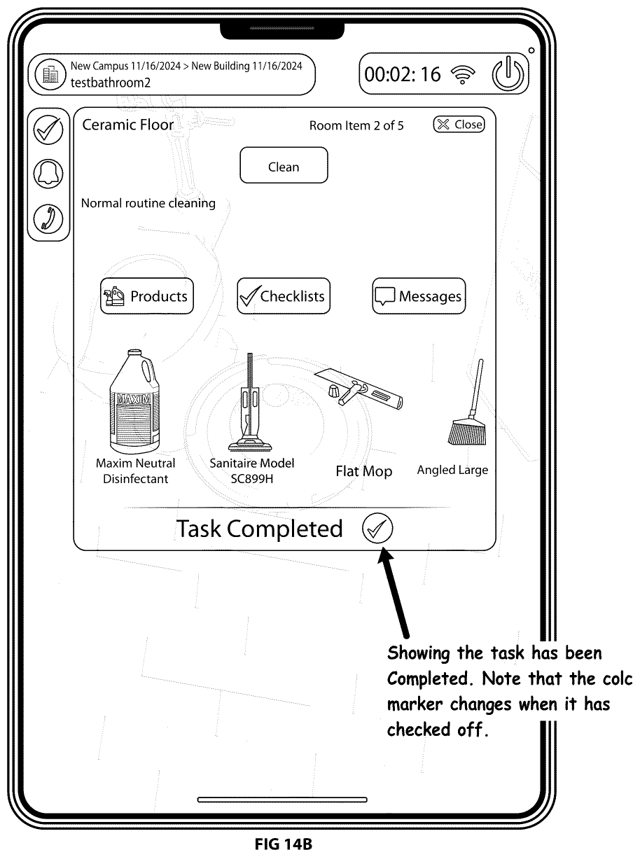

FIGS. 7B-13B show potential training interactions of the trainee that may occur prior to marking completion of the cleaning task, which occurs in FIG. 14B.

In FIG. 7B the trainee is shown accessing information about a disinfectant cleaner to be used in cleaning the bathroom. The trainee clicks on label information, which is shown displayed in FIG. 8B.

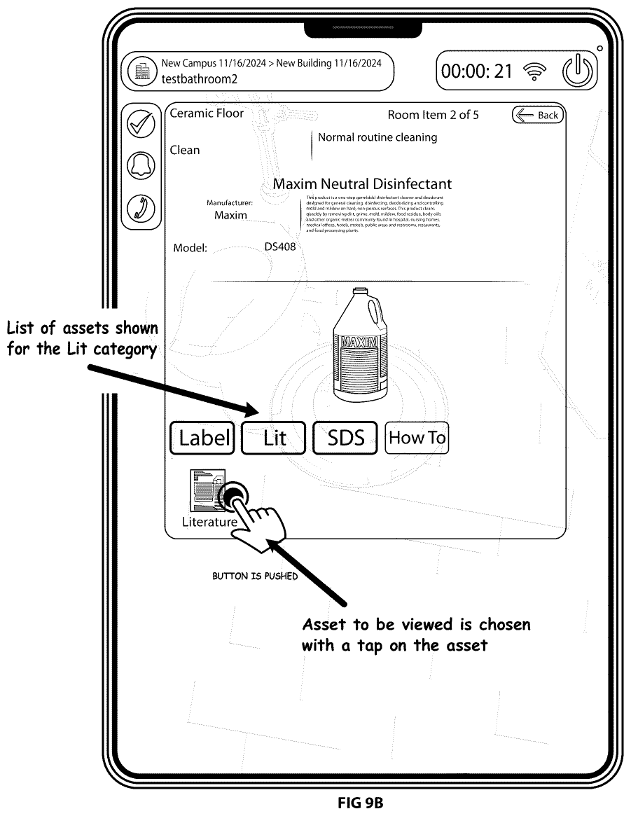

In FIG. 9B the trainee is seen accessing literature information about the disinfectant cleaner, which appears and can be clicked on by the trainee to read.

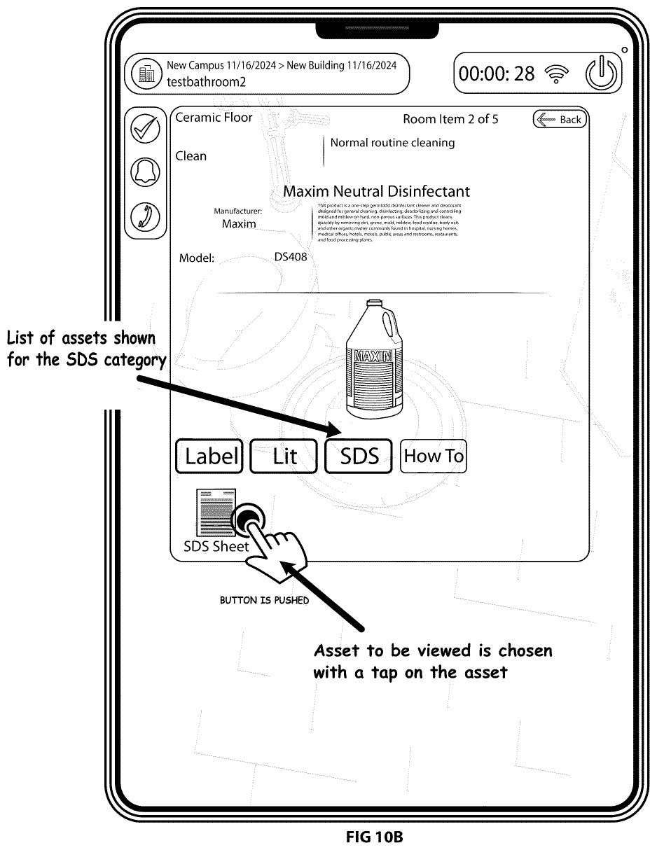

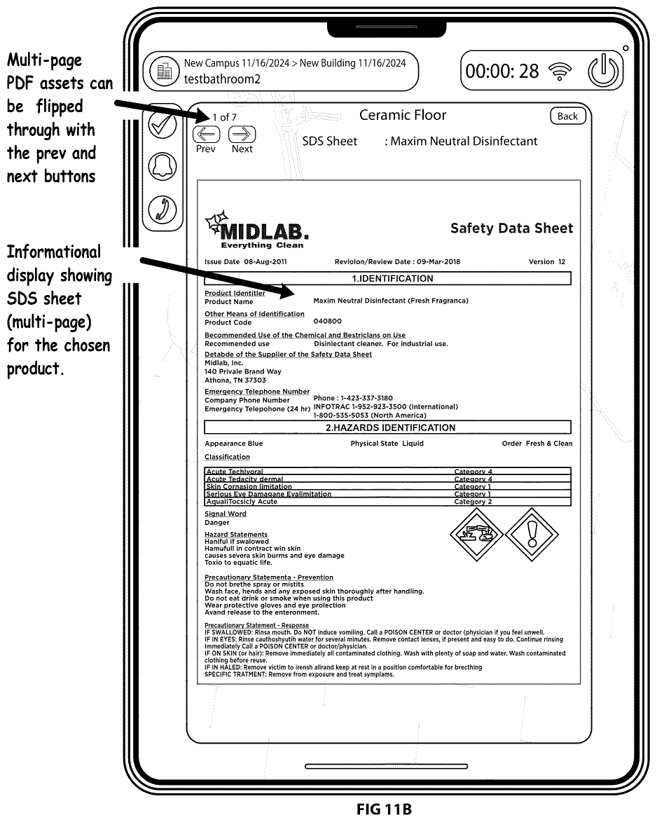

In FIG. 10B the trainee is shown accessing Safety Data Sheet (SDS) information about the disinfectant cleaner, which appears and can be clicked on to read, as shown in FIG. 11B.

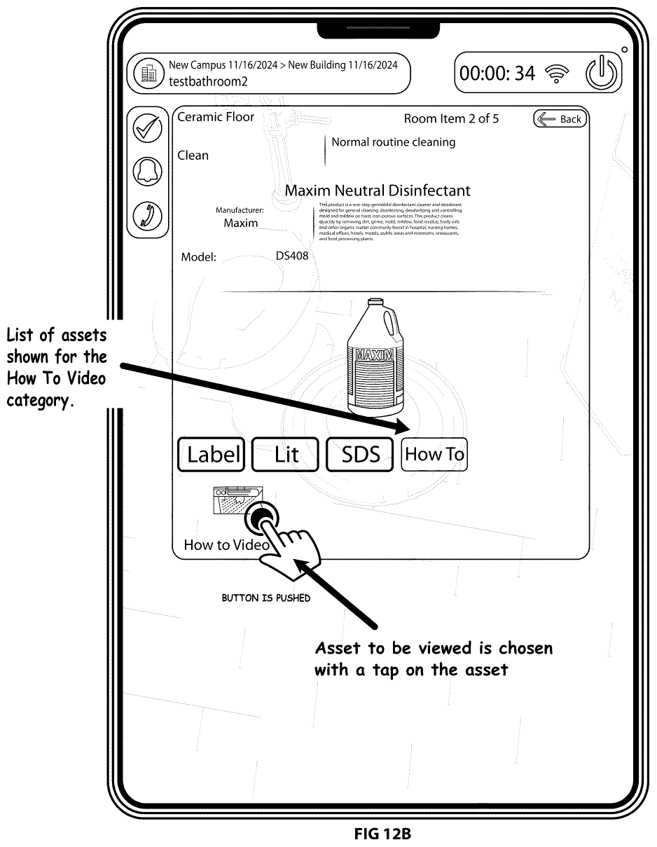

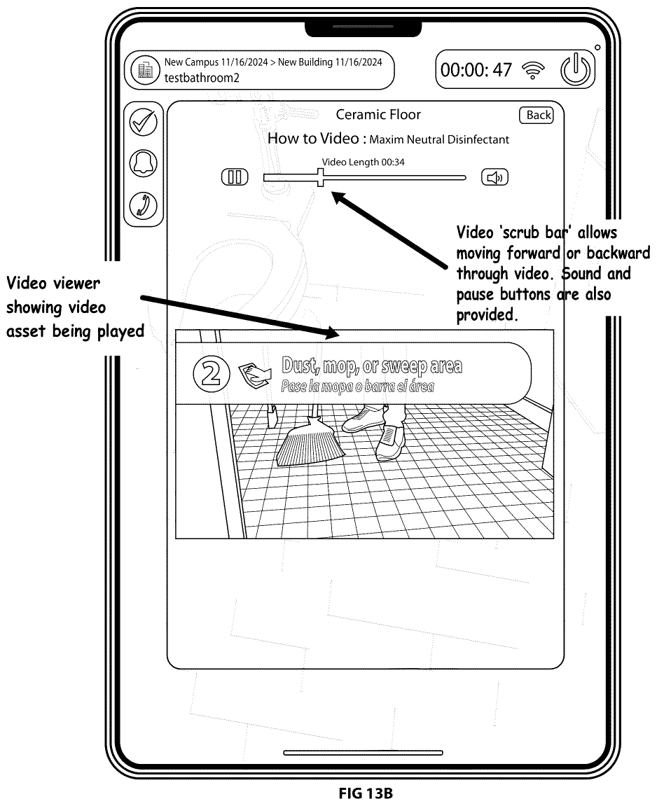

In FIG. 12B the trainee is shown accessing “How To” information, which appears in a pre-selected order at the bottom for access. The first information is a “How To” video which the trainee watches as shown in FIG. 13B.

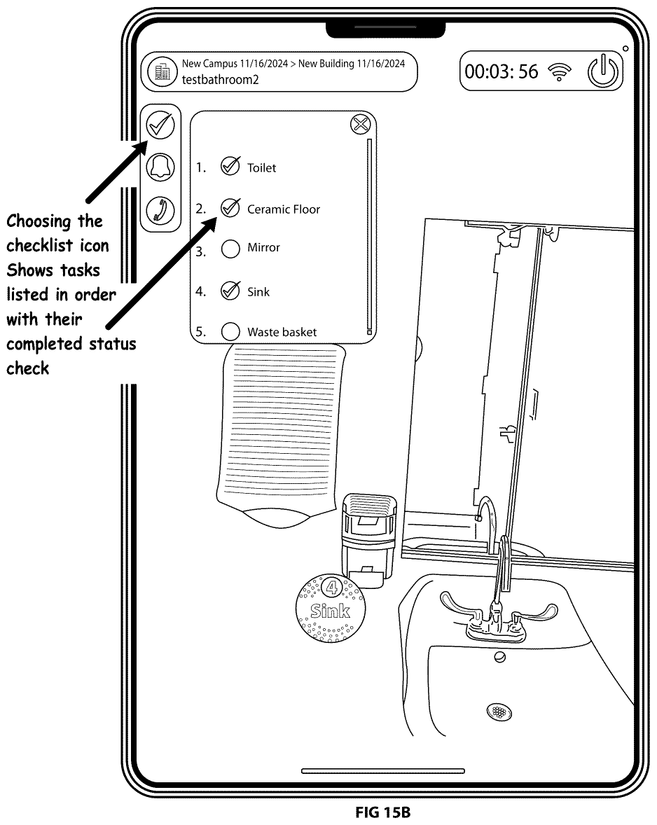

FIG. 14B depicts the trainee completing the training for the disinfectant cleaner by clicking Task Completed. The trainee will then repeat the steps of FIGS. 7B-13B with each of the cleaning products listed. When fully completed with each, the trainee will click Tasks Competed and be directed to the display to repeat the foregoing with another one of the displayed surfaces, such as toilet or sink, as depicted in FIG. 15B.

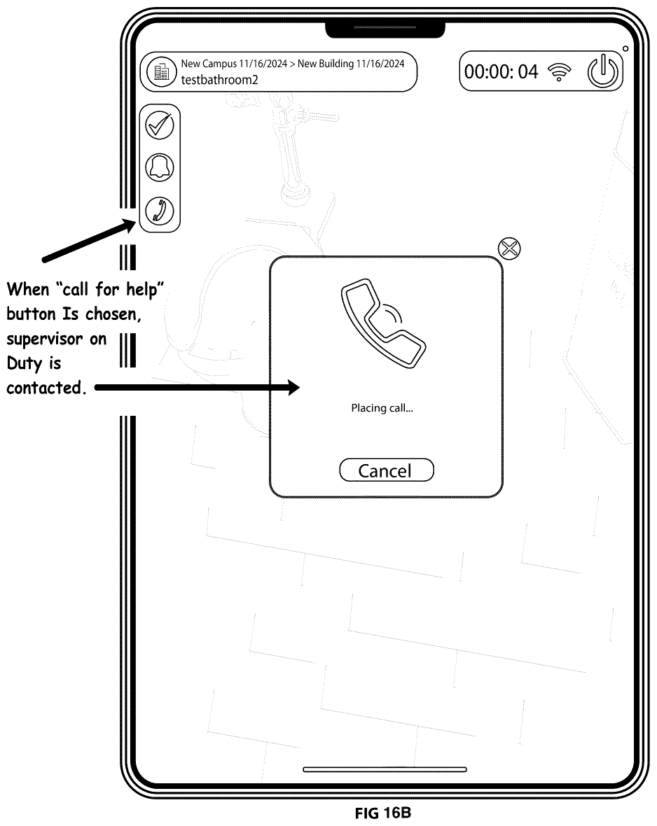

FIGS. 16B-18B depict a messaging feature of the training system whereby the trainee can communicate directly with the trainer. While this is also a safety feature in the event an emergency arises, this feature is normally utilized for permitting personal interaction at portions of the training where the trainee determines they need such help. This two-way communication features instant chat and call initiation between trainees and trainers/supervisors. Two-way visual screen sharing allows trainers/supervisors to see through the lens of the trainee and instruct verbally as well as interaction with the screen images. The system also is able to track the duration of the two-way communications for better time management. Further, trainers/supervisors may initiate calls to trainees.

The messaging feature also enables trainees to receive messages from the trainer/supervisor on an individual or group basis. Messages may be targeted to specific rooms or room types. The messaging feature enables acknowledgement of messages with timestamp for accountability.

### FIGS. 1C-15C

With reference to FIGS. 1C-15C, the interactive training system is shown as used by a trained graduate to receive reinforcement and support after training. As noted, the displays are similar to those previously described for the trainee, but do not need to set the anchor corner or utilize the surface markers. The views are from the perspective of the trained graduate viewing the screen of the tablet 10 and the selected room.

As seen in FIG. 1C, the trained graduate accesses the training system using username/passcode and the system recognizes the person as a trained graduate, and in FIG. 2C the trained graduate is prompted to scan the room QR code 16 or select the room from a menu.

As will be noted, the trained graduate does not need to set an anchor corner or interact with the surface markers. Instead, as shown in FIG. 3C the trained graduate selects the room surface of interest from a displayed list, which displays the room surfaces in the order they are to be cleaned.

Next, as seen in FIG. 4C, the trained graduate is guided in the order of use of the products to be used for cleaning the selected room surface. As depicted in FIGS. 5C-11C, the trained graduate can access the materials accessed during training if they require any reinforcement of their training.

As seen in FIG. 12C, the progress and sequence of cleaning of the room by the trained graduate, and the time for each task, is monitored.

If the trained graduate needs to communicate with the trainer or like person, they can as depicted in FIGS. 13C-15C. The additional messaging features discussed above for use with trainees are also provided for use with trained graduates.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed:

1. A method of anchoring an augmented reality experience for an interactive system for training and guiding cleaning professionals in the use of janitorial and cleaning product to clean surfaces within a plurality of rooms of a facility, the method comprising the steps of:
(1) providing a database of information about the facility and the rooms of the facility to be cleaned, the information including a name for the facility and names of the rooms of the facility and locations of the rooms at the facility;
(2) having a trainer select and set up one of the rooms to be cleaned for interaction with a trainee learning how to clean the room, by: a.) selecting one of the rooms and accessing via a trainer computer the database of information corresponding to the selected room, wherein the interactive system recognizes the trainer and loads pre-selective interactive display screens for interaction with the trainer, b) scanning the selected room with the trainer computer to generate and store an augmented reality map of room surfaces in the room, with the interactive system also displaying an aerial view of the room and prompting the trainer to select a trainer anchor corner in the room that is selectable from the aerial view of the room displayed to the trainer and is a physical and fixed corner of the room, c) interacting with the augmented reality map and selecting surfaces in the room on the map and selecting a surface name for selected surfaces and setting surface markers on the map for each of the selected surfaces to provide room information for each of the selected rooms, the interactive system creating a checklist of the selected surfaces, and saving the room information for the selected room; and
(3) having a trainee interact with the training system to receive training, by: a. the trainee going to one of the rooms selected by the trainer and having a trainee computer that recognizes the trainee, the trainee accessing the room information saved by the trainer for the selected room, b. the trainee computer displaying to the trainee the stored augmented reality map of the selected room with the surface markers set by the trainer and the aerial view of the scanned room, c. the trainee being directed by the trainee computer to select from the displayed aerial view and augmented realty map a trainee anchor corner to match the trainer anchor corner left by the trainer, and d. the trainee selecting one of the surface markers and the trainee computer displaying to the trainee one or more tasks to be performed by the trainee, with the trainee thereafter taking action to complete the task, and interacting with the trainee computer to indicate that the task has been completed by the trainee.

2. An interactive system for training and guiding cleaning professionals in the use of janitorial and cleaning product to clean surfaces within a plurality of rooms of a facility, the system comprising:
(1) a database of information about the facility and the rooms of the facility to be cleaned, the information including a name for the facility and names of the rooms of the facility and locations of the rooms at the facility;
(2) a trainer mode used by a trainer to select and set up one of the rooms to be cleaned for interaction with a trainee learning how to clean the room, the trainer mode including the steps of:
a. the trainer selecting one of the rooms and accessing via a trainer computer the database of information corresponding to the selected room, wherein the interactive system recognizes the trainer and loads pre-selective interactive display screens for interaction with the trainer,
b. the trainer scanning the selected room with the trainer computer to generate and store an augmented reality map of room surfaces in the room, with the interactive system also displaying an aerial view of the room and prompting the trainer to select a trainer anchor corner in the room that is selectable from the aerial view of the room displayed to the trainer and is a physical and fixed corner of the room,
c. the trainer interacting with the augmented reality map and selecting surfaces in the room on the map and selecting a surface name for selected surfaces and setting surface markers on the map for each of the selected surfaces to provide room information for each of the selected rooms, the interactive system creating a checklist of the selected surfaces, and
d. the trainer saving the room information for the selected room; and
(3) a trainee mode in which a trainee interacts with the training system to receive training, the trainee mode including the steps of:
a. the trainee being directed by the trainer to one of the rooms selected by the trainer and having a trainee computer that recognizes the trainee, the trainee accessing the room information saved by the trainer for the selected room,
b. the trainee computer displaying to the trainee the stored augmented reality map of the selected room with the surface markers set by the trainer and the aerial view of the scanned room,
c. the trainee being directed by the trainee computer to select from the displayed aerial view and augmented realty map a trainee anchor corner to match the trainer anchor corner left by the trainer, and
d. the trainee selecting one of the surface markers and the trainee computer displaying to the trainee one or more tasks to be performed by the trainee, with the trainee thereafter taking action to complete the task, and interacting with the trainee computer to indicate that the task has been completed by the trainee.

3. The system of claim 2, wherein the stored augmented reality map of the selected room viewed by the trainee with the surface markers set by the trainer, displays the surface markers to include a number based on a desired cleaning order set by the trainer.

4. The system of claim 2, wherein the system enables the trainee and the trainer to communicate directly with one another, with the trainer being able to view the augmented reality map being viewed by the trainee and to verbally interact with the trainee and to interact with the augmented reality map being viewed by the trainee.

5. The system of claim 2, the system further includes a trained graduate mode in which a trained graduate interacts with training system and the room information saved by the trainer to receive reinforcement and support after training and to track the activities of the trained graduate as they perform their cleaning activities.

6. The system of claim 5, wherein the trained graduate selects one of the surface markers and the trained graduate is guided in the order of use of products to be used for cleaning the room surface corresponding to the selected surface marker.

7. The system of claim 5, wherein the system enables the trained graduate and the trainer to communicate directly with one another, with the trainer being able to view the augmented reality map being viewed by the trained graduate and to verbally interact with the trained graduate and to interact with the augmented reality map being viewed by the trained graduate.
